(19) United States
(12) Patent Application Publication
(10) Pub. No.: US 2015/0301213 A1
(43) Pub. Date: Oct. 22, 2015

(54) A METHOD FOR PROCESSING ACOUSTIC WAVEFORMS

(71) Applicant: SCHLUMBERGER TECHNOLOGY CORPORATION, Sugar Land, TX (US)

(72) Inventors: Timur Vyacheslavovich ZHARNIKOV, Moscow (RU); Denis Evgenievich SYRESIN, Kanagawa-ken (JP); Masafumi FUKUHARA, Sagamihara (JP); Takeshi ENDO, Sagamihara (JP); Hiroaki YAMAMOTO, Sagamihara (JP)

(21) Appl. No.: 14/648,627

(22) PCT Filed: Nov. 30, 2012
(86) PCT No.: PCT/RU2012/000990

§ 371 Date: May 29, 2015

(51) Int. Cl. G01V 1/48

(52) U.S. Cl. CPC G01V 1/48

(57) ABSTRACT

A method for processing acoustic waveforms comprises acquiring acoustic waveforms in a borehole traversing a subterranean formation and transforming at least a portion of the acoustic waveforms to produce frequency domain signals. Then model dispersion curves are generated based on an anisotropic borehole-formation model having a set of anisotropic borehole-formation parameters. The frequency-domain signals are back-propagating using the model dispersion curves to correct dispersiveness of the signals and coherence of the back-propagated signals is calculated. Alternatively the difference between the measured and the model dispersion curves is determined. Model parameters are iteratively adjusted until the coherence reaches a maximum or exceeds a selected value, or alternatively until the difference between the measured and the model dispersion curves becomes minimal or is reduced to below a selected value. Then at least a portion of the set of anisotropic borehole-formation parameters is obtained.

### FIELD OF THE INVENTION

The invention relates generally to acoustic well logging. More particularly, this invention relates to acoustic well logging techniques useful in determining formation properties.

### BACKGROUND OF THE INVENTION

In acoustic logging, a tool is lowered into a borehole and acoustic energy is transmitted from a source into the borehole and the formation. The acoustic waves that travel in the formation are then detected with an array of receivers. These waves are dispersive in nature, i.e. the phase slowness is a function of frequency. This function characterizes the wave and is referred to as a dispersion curve. A challenge for processing acoustic data is how. to correctly handle the dispersion effect of the waveform data.

Important step in processing acoustic logging data is dispersion analysis, that is, its optimal decomposition in limited number of modes in frequency-wavenumber domain, for example, based on Prony's method (S. W. Lang et al., “Estimating slowness dispersion from arrays of sonic logging waveforms”, Geophysics, v. 52, No. 4. p. 530-544, 1987). That is, it tries to find best fit of the signal by a limited sum of complex exponents. Its results are further used to extract information about elastic properties of formation. One of the ways to do it is to compare measured dispersion curves with a reference dispersion curve calculated under certain assumptions.

Current reference dispersion curves are calculated in several ways. For isotropic and VTI (vertically transversely isotropic) formations an analytical solution for radially layered medium is available and can be used to calculate dispersion curves by mode-search type of routines (B. K. Sinha, S. Asvadurov, “Dispersion and radial depth of investigation of borehole modes”, Geophysical Prospecting, v. 52, p. 271, 2004). The limitation is that they require a circular borehole and are not available for anisotropic or irregular formations. Direct 3D modeling of wavefield can be employed (P. F. Daley, F. Hron, “Reflection and transmission coefficients for transversely isotropic media”, Bulletin of the Seismological Society of America, v. 67, p. 661 1977; H. D. Leslie, C. J. Randall, “Multipole sources in boreholes penetrating anisotropic formations: numerical and experimental results”, JASA, v.91, p. 12, 1992; R. K. Mallan et al., “Simulation of borehole sonic waveforms in dipping, anisotropic and invaded formations”, Geophysics, v. 76, p. E127, 2011; M. Charara et al., “3D spectral element method simulation of sonic logging in anisotropic viscoelastic media”, SEG Exp. Abs., v. 30, p. 432, 2011). The problem of these methods is heavy computational requirements. A dispersion curve of a guided wave involves numerous model parameters. Even in the simplest case of a fluid-filled borehole without a tool, six parameters are needed to calculate the dispersion curve (i.e., a borehole size, formation P- and S-velocities and density, and fluid velocity and density). In an actual logging environment, other unknown parameters, such as changing fluid property, tool off-centering, formation alteration, etc., also alter the dispersion characteristics. Therefore a need remains for fast and efficient calculation of dispersion curves with allowance for arbitrary anisotropy, formation radial and azimuthal inhomogeneity (including radial profiling, borehole irregularity and stress-induced anisotropy, etc.) and tool eccentricity.

In principle, possible main steps of sonic logging and data processing are well known and documented, such as firing acoustic signal with the transmitter and obtaining waveforms at receivers, extracting low frequency asymptote of the dispersive signal, comparing with the model dispersion curves, etc. However, practical processing, which includes the step of comparing the measured data with the modeled dispersion curves is currently limited to isotropic or TIV formations. Performing this step for other types of anisotropic formations (general anisotropy) is impractical because either the accuracy is not always sufficient or controllable (perturbation theory approach, etc.) or the computation time is prohibitively large (full 3D wavefield modeling, etc.). The proposed invention rectifies this deficiency and demonstrates the algorithm to solve this problem both accurately and in time, which is acceptable for practical purposes. Therefore, it allows the processing to be done for the completely new class of rock formations—arbitrary anisotropy with spatial variation. At the moment, it is not possible to do by any other means with acceptable accuracy and speed. As a result, it is drastic change in the capabilities of the existing process and makes for the whole new process. The capabilities include possibility of taking into account and treating formations of arbitrary anisotropy (arbitrary symmetry class), arbitrary radial and azimuthal variation of formation physical properties. Axial variation of properties can be, in principle, also taken into account. This completely new capability. Computational efficiency allows the proposed invention to be used for the well-site modeling of dispersion curves for general anisotropic formations, which is also new. The requirements for the computational power are drastically reduced (orders of magnitude both in time and hardware (memory, number of CPUs, etc.) requirements). For well-site or further processing significant improvement of computational efficiency implies increased turnaround time of data processing, interpretation, answer products, etc. This capability is new with respect to the currently available approaches.

### SUMMARY OF THE INVENTION

In accordance with one embodiment of the invention, a method for processing acoustic waveforms comprises acquiring acoustic waveforms in a borehole traversing a subterranean formation, transforming at least a portion of the acoustic waveforms to produce frequency domain signals, generating model dispersion curves based on an anisotropic borehole-formation model having a set of anisotropic borehole-formation parameters by specifying governing equations, finding a matrix representation of the governing equations' operator and an operator of boundary and interface conditions in some functional basis, truncating and discretizing the resulting set of equations by truncating the functional basis and finding the spectrum by directly solving the generalized eigenvalue problem or the linear matrix equation, back-propagating the frequency-domain signals using the model dispersion curves to correct dispersiveness of the signals, calculating coherence of the back-propagated signals, iteratively adjusting model parameters until the coherence reaches a maximum or exceeds a selected value, outputting at least a portion of the set of anisotropic borehole-formation parameters.

A method for processing acoustic waveforms according to another embodiment of the invention comprises acquiring acoustic waveforms in a borehole traversing a subterranean formation, generating measured dispersion curves from the acquired waveforms, generating model dispersion curves based on an anisotropic borehole-formation model having a set of anisotropic borehole-formation parameters by specifying governing equations, finding a matrix representation of the governing equations' operator and an operator of boundary and interface conditions in some functional basis, truncating and discretizing the resulting set of equations by truncating the functional basis and finding the spectrum by directly solving the generalized eigenvalue problem or the linear matrix equation, determining a difference between the measured and the model dispersion curves, iteratively adjusting model parameters until difference between the measured and the model dispersion curves becomes minimal or is reduced below a selected value, outputting at least a portion of the set of anisotropic borehole-formation parameters.

### BRIEF DESCRIPTION OF THE DRAWINGS

FIG. 1 is a flow chart of a method of acoustic waveforms processing in accordance with the invention.

### DETAILED DESCRIPTION OF THE INVENTION

Acoustic data acquired with a logging tool are waveforms received by receivers. These waveforms include a large amount of data, which would need to be analyzed with an appropriate method to derive information related to formation properties.

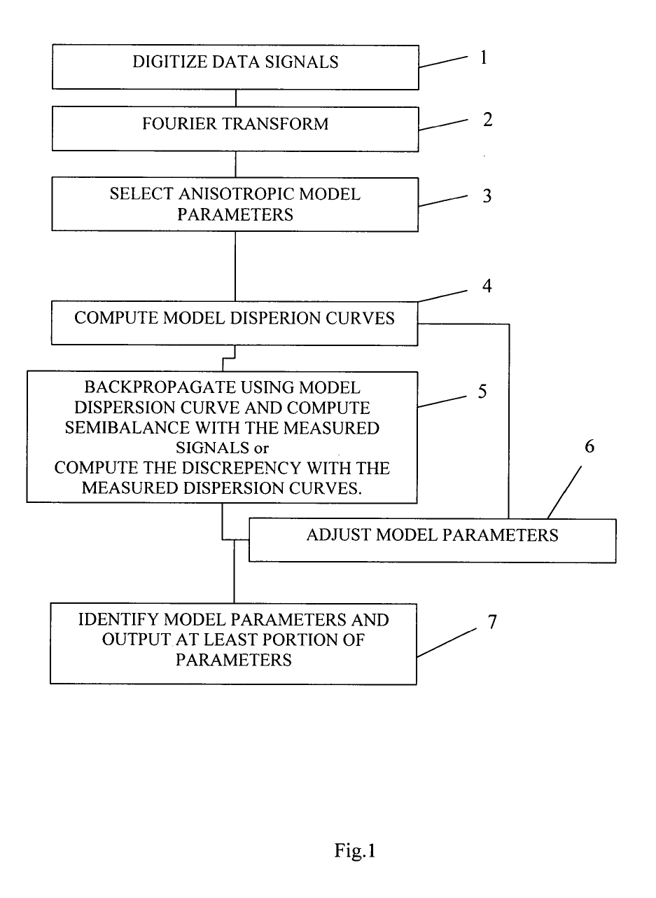

FIG. 1 shows a schematic of a process in accordance with one embodiment of the invention for inverting borehole-formation parameters from acoustic waveforms. As shown, the acoustic waveforms are digitized (step 1 on FIG. 1) and converted into the frequency domain by a suitable transformation (e.g., Fourier Transform (FT) or Fast Fourier Transform FFT)—step 2 on FIG. 1. According to steps 3 and 4 model dispersion curves are generated based on an anisotropic borehole-formation model having a set of anisotropic borehole-formation parameters by specifying governing equations, finding a matrix representation of the governing equations' operator and an operator of boundary and interface conditions in some functional basis, truncating and discretizing the resulting set of equations by truncating the functional basis and finding the spectrum by directly solving the generalized eigenvalue problem or the linear matrix equation.

Then, the frequency domain signals are back propagated using model dispersion curves to correct for dispersiveness of the signals (step on FIG. 1) The back propagation produces back-propagated waveforms, which are in the frequency domain.

Coherence of the back-propagated waveforms is then calculated. The processes of back propagation and computing coherence may be repeated iteratively by obtaining a new set of model dispersion curves that correspond to a different set of borehole-formation parameters (step 6 on FIG. 1). These processes are repeated until the coherence meets a selected criterion, such as reaching a maximum or exceeding a selected value. Then, the borehole-formation parameters are output.

Alternatively, measured dispersion curves can be measured from acquired waveforms. The difference between the measured and the model dispersion curves can be determined (step 5 on FIG. 1) and iteration may be performed adjusting model parameters to produce the minimal difference between the measured and the model dispersion curves or reduce the difference between the measured and the model dispersion curves to below a selected value (step 6 on FIG. 1). The choice of model parameters depends on the particular problem to be solved. For example, if the target is to evaluate elastic moduli of a formation assuming it to be homogeneous tilted transversely isotropic (TTI) one, possible parameters are 5 elastic moduli (C11, C13, C33, C44, C66) and relative dip angle θ. Bulk modulus of a drilling mud can be either taken as known approximately or added to the list of model parameters depending on the processing algorithm. The densities are usually obtained from other measurements.

Then, some or all of the borehole-formation parameters corresponding to the model dispersion curves that produce the minimal difference between the measured and the model dispersion curves are output to provide information on formation properties (step 7 on FIG. 1).

An example of one of the embodiments relates to determination of formation elastic moduli, for instance, 5 TTI parameters which are required for geomechanical applications like determination of well stability, etc. Formation density can be estimated from gamma logs and mud density can be measured or guessed with reasonable accuracy. Similarly, bulk modulus of the drilling mud can be either guessed or, in principle, measured in situ. Then the attenuation in the mud is disregarded and formation is assumed to be homogeneous TTI one. Therefore, one arrives at the problem of determination one parameter of the TTI model (e.g. elastic moduli (C11, C13, C33, C55, C66) from the sonic logging measurement. To address this problem, the invention proposed in this patent is embodied as described below.

Sonic waveforms in a borehole are recorded as dependent on azimuth and vertical coordinate by a typical logging tool. The recorded signals are digitized.

Dispersion curves are estimated from the measured data by any known method (see, for example, S. W. Lang et al., “Estimating slowness dispersion from arrays of sonic logging waveforms”, Geophysics, v. 52, No. 4. p. 530-544, 1987).

Then the initial set of elastic parameters is defined. For example, one can start with the isotropic model whose moduli λ and μ are estimated from the speeds of shear and compressional waves, recorded by the logging tool.

λ=ρ(Vₚ²−2Vₛ²), μ=ρVₛ²

where Vₚ is a P-wave velocity, Vₛ is a shear-wave velocity, ρ is the density.

Then dispersion curves of borehole modes recorded by the tool (e.g. Stoneley, pseudo Rayleigh, dipole flexural, quadrupole modes, etc.) are modeled. The modeling process starts with specifying governing general elastodynamic equations:

−ρω²uᵢ=∂ⱼσᵢⱼ

σᵢⱼ=cᵢⱼᵢₖₗεₖₗ

The matrix representation of the governing equations' operator (e.g. that of anisotropic elastodymanics, viscoelasticity, etc.) and operator of boundary and interface conditions (e.g. free surface, rigid, welded, slip, etc.) are found in some functional basis (for example, time harmonic cylindrical waves e^{i(kz+nθ-ωt)}gₚ(r)).

Thus, Galerkin type approximation is used by expanding the solution of general elastodynamic problem formulation with respect to a set of basis functions. For example, one can use harmonic functions in z, θ, t with interpolation functions gᵢⱼ(r) in r:

$${u}_{i} = \int d k \int d ω {\sum }_{j} {\sum }_{n} {A}_{i} ( n , j , k , ω ) {e}^{i ( kz + n θ - ω t )} {g}_{ij} ( r )$$

Either frequency or wavenumber value can be fixed to reduce one dimension to eigenvalue problem with respect to the wavenumber or frequency in 2D (r−θ).

−ρω²u(k*,ω)= [symbol] (k*,ω)u(k*,ω)

The resulting set of equations is truncated and discretized by truncating the functional basis, which results in the finite size matrix eigenvalue problem (no source) or linear matrix equation (with the source).

Truncate resulting infinite set of equations and obtain finite set of equations:

$$- {ρω}^{2} {\overline{u}}_{m} ( r , {k}^{⋆} ) = A ( r , {n}_{θ} , {k}^{⋆} ) \overline{u} = {\sum }_{\{ n \}} {A}_{mn} ( r , {k}^{⋆} ) {\overline{u}}_{n} ( r , {k}^{⋆} )$$

where [n] is the set of azimuthal harmonics chosen for the approximation of the problem. Supplement them with similar approximation for the boundary and interface conditions.

The spectrum is found by directly solving the generalized eigenvalue problem (no source) or the linear matrix equation (with the source). The eigenvalues and eigenfunctions are processed and classified by selecting those with physical meaning and those which correspond to the mode of interest. This is done using the properties and symmetries of the solutions. For example, dipole flexural can have maximum of coefficients of expansion at n=±1, etc

The generated model dispersion curves are compared with the dispersion curves estimated form the measured data. If there is no difference, initial approximation is considered to be good and the formation parameters are found (C11=λ+2μ, C13=λ, C33=λ+2μ, C55=μ, C66=μ). Otherwise elastic moduli (C11, C13, C33, C55, C66) are adjusted and one goes back to step of modeling dispersion curves.

Modeling and comparison are repeated, until model dispersion curves are considered to match well with the experimental data. At this moment the elastic moduli, for which this match is observed, are considered to describe the formation.

Suggested method is reasonably fast and does not require heavy computational facilities, it works in reasonably wide range of parameters, is sufficiently accurate and robust.

Suggested method affects a number of applications, raising them to the new technology level (which is currently limited due to absence of borehole modes' dispersion curve computation algorithms for anisotropic formations, which are both accurate and computationally efficient). Such applications include, but are not limited to:
Obtaining model dispersion curve based on an anisotropic borehole-formation model (including arbitrary anisotropy; arbitrary radial and azimuthal inhomogeneity; arbitrary spatial inhomogeneity) having a set of anisotropic borehole-formation parameters. The algorithm allows for fast and computationally efficient calculation of dispersion curves for waveguides (including boreholes) with allowance for arbitrary anisotropy, radial and azimuthal inhomogeneity of waveguide properties (including layering, radial profiling, borehole irregularity and stress-induced anisotropy, etc.) and tool and/or layers eccentricity.
Solution of inverse problem and extracting properties of formation by comparing measured dispersion curves with those modeled by the proposed method. It includes radial profiling for cased and open boreholes in anisotropic formation.
Survey parameter decision/optimization at wellsite or prior to the job.
Estimation of mode contamination in complex borehole environments and vice versa evaluation of borehole parameters from mode contamination information.
Quality control of the results obtained in previous items.
Determination of elastic moduli. E.g. TTI parameters.
Check of and comparison of the modeled dispersion curves with the results of dispersion analysis of measured data.
The interpretation of sonic data. Determination of the elastic moduli, identification of local parameter variations and verification of the results.
Well development decisions. E.g. geomechanical applications like well stability, etc. Also for example for horizontal wells, gas shale wells, etc. For example, local variations of elastic moduli can be used to plan and improve completion decisions, geomechanical decisions, fracturing jobs design.
Possibly for LWD shear evaluation from monopole pseudo Rayleigh wave.

1. A method for processing acoustic waveforms comprising:
acquiring acoustic waveforms in a borehole traversing a subterranean formation,
transforming at least a portion of the acoustic waveforms to produce frequency-domain signals,
generating model dispersion curves based on an anisotropic borehole-formation model having a set of anisotropic borehole-formation parameters by specifying governing equations, finding a matrix representation of the governing equations' operator and an operator of boundary and interface conditions in some functional basis, truncating and discretizing the resulting set of equations by truncating the functional basis and finding the spectrum by directly solving the generalized eigenvalue problem or the linear matrix equation,
back-propagating the frequency-domain signals using the model dispersion curves to correct dispersiveness of the signals,
calculating coherence of the back-propagated signals, iteratively adjusting model parameters until the coherence reaches a maximum or exceeds a selected value, and
outputting at least a portion of the set of anisotropic borehole-formation parameters.

2. Method of claim 1 wherein acoustic waveforms comprise signals from a Stoneley mode, a dipole mode, or a quadrupole mode.

3. Method of claim 1 wherein acoustic waveforms are converted into the frequency domain signals by Fourier transforming or Fast Fourier Transforming.

4. Method of claim 1 wherein a Galerkin type approximation is used for the matrix representation.

5. Method of claim 1 wherein a frequency or a wavenumber value is fixed to reduce one dimension to eigenvalue problem with respect to the wavenumber or frequency in 2D (r−θ).

6. A method for processing acoustic waveforms comprising:
acquiring acoustic waveforms in a borehole traversing a subterranean formation,
generating measured dispersion curves from the acquired waveforms,
generating model dispersion curves based on an anisotropic borehole-formation model having a set of anisotropic borehole-formation parameters by specifying governing equations, finding a matrix representation of the governing equations' operator and an operator of boundary and interface conditions in some functional basis, truncating and discretizing the resulting set of equations by truncating the functional basis and finding the spectrum by directly solving the generalized eigenvalue problem or the linear matrix equation,
determining a difference between the measured and the model dispersion curves,
iteratively adjusting model parameters until the difference between the measured and the model dispersion curves becomes minimal or is reduced to below a selected value, and
outputting at least a portion of the set of anisotropic borehole-formation parameters.

7. Method of claim 6 wherein acoustic waveforms comprise signals from a Stoneley mode, a dipole mode, or a quadrupole mode.

8. Method of claim 6 wherein a Galerkin type approximation is used for the matrix representation.

9. Method of claim 6 wherein a frequency or a wavenumber value is fixed to reduce one dimension to eigenvalue problem with respect to the wavenumber or frequency in 2D (r−θ).
